(19) United States
(12) Patent Application Publication
(10) Pub. No.: US 2022/0237640 A1
(43) Pub. Date: Jul. 28, 2022

(54) System and Method for Using Observational Datasets to Improve Hotel Revenue Estimates and Associated Economic Impact in Real-Time

(71) Applicant: Arrivalist Co., New York, NY (US)

(72) Inventor: Cree Lawson, New York, NY (US)

(21) Appl. No.: 17/158,734

(22) Filed: Jan. 26, 2021

(51) Int. Cl. G06Q 30/02; G06Q 10/10; G06Q 50/14; G06Q 50/12; G06F 16/29; G06F 16/27

(52) U.S. Cl. CPC G06Q 30/0205; G06Q 30/0201; G06Q 10/10; G06Q 50/14; G08G 1/0104; G06F 16/29; G06F 16/27; G06Q 30/0247; G06Q 30/0254; G06Q 50/12

(57) ABSTRACT

The present invention is a system and method for improving the accuracy with which marketing efficacy can be measured and improved using human behavioral insights. The process aligns at least two different data sets and normalizes the information by removing statistical bias. In a particular implementation motor vehicle data is collected by census of hotelier transaction data. The transaction data is overlaid upon observed vehicle data which is captured by a triggering event. The system statistically analyses the data resulting from the combined data sets and provides a report with a recommendation to a human user.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Municipal departments of transportation answerable to city, state and federal officials are commonly tasked with measuring metrics associated with tourism and travel. Such metrics are used by city, state and federal planners to allocate scarce resources and prioritize assets for repair or in anticipation of travel growth. Owners and managers of tourist attractions, hotels, airports, shopping centers and performance venues similarly relay on such developed metrics to plan for and manage economic growth or decline.

One particularly useful metric to determine the economic impact of visitation to an area is hotel occupancy for a given area during a particular date range. Marketers collect census-type data directly from hoteliers; such data typically includes the number of hotel rooms occupied on a daily basis and the average rate paid per room. This average is referred to within the hospitality industry as the Average Daily Rate (ADR). Similar census data can be collected from payment providers such as credit card processors and banks.

Smith Travel Research is the leading provider of census level data for hotels, whereas Air DNA is the leading provider of similar data for vacation rentals. One can find estimated economic impact from hotel data included in industry reports from companies like Tourism Economics. Companies like VISA, MasterCard and Cardlytics provide card transaction data; Global Distribution Systems (GDS) such as Sabre and Online Travel Agencies (OTAs) such as Expedia also can retain and provide transaction data.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a sub-process for determining data biases in layered data sets consistent with certain embodiments of the present invention.

FIG. 2 is a view of a sub-process for removing data biases and processing a resulting data set consistent with certain embodiments of the present invention.

FIG. 3 is a view of a sub-process for returning initial data sets consistent with certain embodiments of the present invention.

FIG. 4 is a view of a sub-process for data collection and analysis consistent with certain embodiments of the present invention.

FIG. 5 is a view of a sub-process for determining changes in origin markets over time consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “Global Positioning System (GPS)” refers to the satellite-based radio-navigation system operated by the United States Space Force.

Reference throughout this document to “overlay” or “data overlay” refers to transfer of information from one data file to another data file lacking some information by matching records on the receiving file to records on the file that already includes the desired information. By way of non-limiting example, demographic data may be added to a customer file by overlaying a demographic data file upon the customer file. The match may be accomplished, by way of non-limiting example, on a geographic level (such as with reference to a postal code) or on a household level (such as with reference to a home address) or any other level as specified by the user.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or “analyzing” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMS). EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Although a variety of municipalities and third-party data analysts have pioneered ways to use census data to estimate hotel revenue, current means of estimating hotel revenue are not representative of all lodging arrangements within a geographical area. Because current methods do not include data from all lodging providers in an area, the calculable results are limited to the lodging-providing properties which participate or provide census level data for every property for every night. In addition, currently collected data is also limited to that originating within formally constructed and regulated commercial hotel properties used for providing overnight stays. Such data is commonly collected by the formal hotelier or in conjunction with payment providers such as credit card companies and/or banks. Consequently, current methodologies of calculating the actual or potential economic impact from overnight lodgers do not include the economic impact from lodgers who elect to stay in privately maintained vacation rental properties or at the residences of friends and/or relatives. Even among the participating subset of hoteliers that take a census of lodgers, there are delays in accessing census data. The data entry and transmission (whether manual or automated) required to process such census level data often delays the delivery of data and insights by days or even a week, making the information too stale for enacting short-term planning processes and deriving actionable consumer behavioral insights.

Thus, there is a need for a system and method for using observational data, rather than census data alone, to estimate visitor overnight stay occupancy in a manner that allows for faster data processing and yielding of human behavioral insights. To be optimally actionable, such data calculations can be arrived at within a matter of minutes of the observational data's being recorded.

In an embodiment, observational data such as the movement of vehicles or digital devices associated with a person into and out of hotels or hotel parking lots is used to estimate the occupancy of a given hotel during a particular period of time. The system provided for herein multiplies that estimated occupancy of a property or range of properties (in the case of closely-geographically-grouped accommodations) by the estimated or calculated dollar-value transaction data for the same period of time. The resulting multiple yields the estimated revenue of the property or properties. Further calculations from the same data can reveal the economic impact of travel in a particular area. Additional data analysis with a focus on visitor origin can be used to provide real time insights on which areas of origin are creating the most spending at the hotel property or properties, and/or the area it serves.

In an embodiment, data collected by the instant innovation permits destination marketers to estimate hotel spending in a particular area over a particular time. Similarly, the instant innovation permits marketers that promote a particular region to calculate return on their marketing investments. Hoteliers can use the data set in a similar fashion, adding the ability to compare regions with rising or falling hotel spending or increasing or shrinking share of market compared to alternative lodging. Additional analysis of data permits the classification of visitors into classes of hotels and the origin markets for each hotel property. The system may classify hotel properties into luxury, midscale, discount, independent, and additional classes that may be approved as circumstances warrant. The system analyzes the captured data to determine which origin market users are most likely to stay at certain classes of hotels based upon the visitor origin and the class of hotel in which each visitor stays. This information permits the system to capture the hotel classes and visitor origins for each stay and report this information as additional insights to the users of the system.

In an embodiment, the instant innovation utilizes observationally-derived datasets that are overlaid upon census-derived datasets to develop insights into the travel behavior of humans operating within a geographical area. The system uses observational data sets derived from observational devices such as, by way of non-limiting example, mobile devices, cameras, and/or from area ingress and egress sensors to augment census-derived data sets. In an embodiment, a vehicle which triggers an ingress sensor of any type at Time 1 sets Time 1 as the origin point upon a master timeline from which all subsequent trigger events may be calculated. If for example after triggering an ingress sensor at Time 1, a vehicle does not trigger an egress sensor for a period longer than eight hours (or some other given period), the system may calculate that the vehicle operator has sought overnight lodging. If analysis of mobile device GPS data shows that the vehicle was near one or more hotels during the eight-hour period, then the system may further calculate that the vehicle operator sought lodging in one of those one or more hotels. The system may develop similar insights into the behavior of a vehicle operator who seeks lodging with a friend or family member, or at some alternative lodging.

In an embodiment, the observationally-derived data sets may be overlaid upon hotel Average Daily Rate data to permit the system to confirm that the vehicle operator stayed at a given hotel, or to confirm that the vehicle operator did not stay at any formal lodging provider in a given geographic area. All data sets described herein are associated with a time-stamp which evidences the exact time at which the data point was created. Cross-comparison of data points aligned as to timestamps permits the present innovation to derive metrics regarding the percentage of vehicles and/or vehicle occupants to have gained lodging in a particular place. In an embodiment, non-lodging derived metrics may be derived for other venues, including by way of non-limiting example, theme-parks or local attractions.

In an embodiment, the instant innovation uses observational datasets (such as the discernable movement of vehicles or digital devices associated with a person) to improve current methods for estimating hotel revenue and economic impact. The observational data sets may be derived in response to the triggering of ingress and/or egress sensors and the time-stamped indicia of such triggering event. Similarly, the observational data sets may be derived by collection of time-stamped mobile device GPS data. The observational data sets may be augmented or replaced by additional observed data sets from time-stamped camera, satellite, or traffic data monitors. By way of non-limiting example, the instant innovation makes possible the accelerating of data processing time from one week to a matter of hours; the estimating of revenue from all properties within a geographic area, rather than solely from participating properties that engage in data collection; the including of economic impact from stays at hotel casinos and amusement parks, which do not typically participate in census data collection or share transaction data with third parties; the including of estimated revenue from non-traditional lodging, or non-commercial buildings like vacation rentals in calculations; and the identifying of potential revenue from overnight stays at personal residences, or visitors who are visiting friends and relatives (VFR).

In an embodiment, the system collects one or more observational datasets, each collected dataset being representative of substantially all visitation to the properties in a geographic area, as well as all vehicle movement and location data whether or not associated with a residence, amusement, or overnight stay property. Such datasets may be captured by traffic data monitors such as, by way of non-limiting example, pneumatic tubes, cameras, or other sensors that record vehicle motion within an area or that are triggered by a vehicle's ingress and/or egress into or out of a discretely bounded area, such as a parking lot. Datasets may also be collected from other sources including, by way of non-limiting example, smartphones or other digital devices associated with a person. The instant innovation utilizes times stamps to align data sets from one or more sources. In an embodiment, time stamps are associated with each data set and serve as a single source of temporal alignment across all data sets. When one data set, whether observational or census, is compared to another data set, the aligned time stamps permit the system to develop insights into a vehicle operator's behavior along a master timeline.

In an embodiment, the system collects daily monetary transaction data for the property or properties within the geographic area of interest where this data includes timestamped information for when a vehicle is located at a hotel, amusement, or any other overnight stay property. Such transaction data may be aggregated across all hotel room inventory or broken down by room type. Optionally, the system collects data reflecting the number of rooms sold or occupied within the area of interest on a given night. The system collects data reflecting the number of rooms in a given property, the property's physical address, and the number of properties which are open for business in the particular area at a particular time. The system also collects tax rates for properties within the particular geographic area.

In an embodiment, the instant innovation calculates the fiscal impact of hotel spending by taking the property occupancy as derived from observational datasets and multiplying it by the Average Daily Rate (ADR) of the property. This is a novel use of the ADR. The ADR dataset is combined (overlaid) with vehicle location information to derive insights regarding the geographic origin information for each vehicle, the length of time the vehicle is located at the hotel property, the number of times the vehicle may be located at the hotel property in a given timeframe (Month, year, etc.), and how much revenue may have been generated to the hotel by the occupants of the vehicle during each stay at the hotel. These insights may be used to target advertising expenditures to geographic locations (as represented by ZIP codes) from which multiple visits are recorded, and from which longer stays per visit are recorded. Additionally, these data may be aggregated and analyzed over a time frame such as a month, quarter, or year to derive insights as to how visits may be changing dynamically over a specified period of time from each geographic location. These changing location insights may inform the hotel as to the efficacy of spending on advertising in a particular geographic location over a pre-determined time period.

In an embodiment, the instant innovation uses specially built models to provide useful fiscal calculations in real time. By way of non-limiting example, a destination marketer for a representative hypothetical town (Anytown, USA) may want to calculate its own economic impact upon Anytown on a day-by-day basis. Assume by way of non-limiting example that the Destination Marketer has 100 hotels within its purview and that each hotel has 100 rooms to rent. Assume further that the average daily room rate (ADR) is $100 and that 10% of a given hotel's revenue goes to local taxes. Assume that the marketer spends $1000/day to market the destination, and that on Jul. 4, 2020 the observational dataset showed 50% occupancy.

To arrive at economic impact for Jul. 5, 2020 the instant innovation multiplies the occupancy (50%) times the ADR ($100) times the 100 hotels times the number of rooms, times the taxes collected (10%) to arrive at a total economic impact of $500,000. The instant innovation may calculate generated tax revenue to be $50,000, making the return on marketing investment 50:1 or $50 in tax revenue from every $1,000 invested in marketing by the Destination Marketer.

The instant innovation may determine the economic impact to Hoteliers by altering the above-described method. The system achieves this result by replacing the tax factor with a profit margin factor in the foregoing equation.

In an embodiment, the instant innovation allows for the use of origin markets in calculations. By way of non-limiting example, an observational dataset might reveal that a subset of 10% of visitors to an area on Jul. 5, 2020 resides in postal (ZIP) code 34119. In that case the hotels, destination marketers and travel industry would benefit by knowing that 10% of total revenue (and thus ten percent of associated tax revenue) generated in the area was attributable to residents of postal code 34119.

In an embodiment, observational datasets inclusive of all visitation to an area can also be used to estimate the total overnight stays in a given geographical area or market. For instance, by way of non-limiting example, if an observational dataset revealed that 50% of the visitors to Anytown, USA on Jul. 4, 2020 stayed overnight in Anytown but were not observed at a hotel, then the instant innovation could determine that the remaining 50% of the town's visitors used vacation rentals or informal lodging. If the ADR at vacation rentals was $200/night, and if informal lodging is ignored, the system can calculate the total market for lodging in Anytown on Jul. 4, 2020 to have been $1,500,000, with $500,000 spent at hotels and $1,000,000 spent at vacation rentals. The system can then calculate the tax that would have been collected if all visitors had stayed in hotels alone. The system may similarly calculate visitation at non-hotel properties such as entertainment venues with internal lodging or similar venues.

In an embodiment, the observational and census datasets can be used for marketing return-on-investment calculations such as taking the amount of marketing invested in a particular origin market and calculating the hotel revenue generated from that particular origin market at a particular property or range of properties. For any calculations to be accurate, the system requires data accurately representing the Average Daily Rate and Room Occupancy for discrete periods of time.

In a principal embodiment, the system observes vehicle location from vehicle Global Positioning System (GPS) data or vehicle-conveyed phone GPS data or from one or more Traffic Data Monitors. The Traffic Data Monitor is a sensor-equipped trigger device that that creates a timestamp when a vehicle passes the sensor. Other sensors of this type may be found at the ingress and egress points of discrete areas including but not limited to parking lots and garages. In its fundamental embodiment, the system utilizes ingress and egress sensors, of which a pneumatic Road Rope is a particular mobile trigger sensor, to initialize the action of further data synthesis. Ingress and/or egress sensor types may also include, by way of non-limiting example, cameras, traffic metering crossing bars (and/or crossing bars, generally) and traffic toll booths. In an embodiment, system sensor activation creates a time-stamped data set which can be aligned with other time-stamped data sets. These aligned data sets can be analyzed for human behavioral insights into activity within a geographical area.

In an embodiment, the system can deliver visitation volume insights in real-time, providing accurate estimates of visitor volume with information about visitor origin and destination. The system increases estimate accuracy in part by overlaying time-stamped data from phones or other mobile devices and time-stamped data from traffic data monitors to calculate the total number of people arriving to a destination, as opposed to calculating merely the number of vehicles arriving to that destination. Time-stamped third-party sourced information may be captured in response to a triggering event.

In an embodiment, the present innovation is an analytic software process for increasing the accuracy of insights into human behavioral decisions by combining real-time data from traffic data recorders and automobile location data from sources including, but not limited to, mobile device GPS systems, terrestrial imagery systems and satellite imagery systems.

In an embodiment, the present innovation aligns at least two different time-stamped data sets and normalizes the information contained in the data sets by removing bias from over-indexation within the data sets. In an embodiment, the foregoing process is conducted in real-time, with data analysis, including an estimation of vehicle origin markets, being completed virtually simultaneously with data collection. In so doing, the instant innovation improves the accuracy with which analysts may draw conclusions about the way people and motor vehicles are travelling.

In an embodiment, the instant innovation may overlay vehicle location data with occupancy and ADR data from hotels in order to determine the best origin markets for advertisers to target. The instant innovation may overlay collected census or other data upon observed vehicle data to determine vehicle origin markets as a derived data set. The derived data set may then be combined by overlaying the derived data set with observational data sets and/or census data sets utilizing time-stamped indicia to orient each of the data sets upon a master timeline. In an embodiment, the overlay of data sets permits the instant innovation to determine which if any data fields in one data set are inconsistent with data fields of one or more second data sets and permit the population of empty data fields within the various input data sets to create a combined one or more data sets having more populated data fields.

In an embodiment, if the instant innovation determines that data fields are otherwise inconsistent or contrary, the system can flag any data field for further analysis. By way of non-limiting example, the instant innovation may align one or more observed data sets and census data sets along the master timeline and further align and overlay vehicle registration data sets and/or other vehicle operator data sets. The instant innovation may analyze the totality of combined and overlaid data sets to derive metrics to provide insights on human travel behaviors. By way of non-limiting example, one such travel behavior for which insights may be derived is the number of lodgers in a particular geographic area.

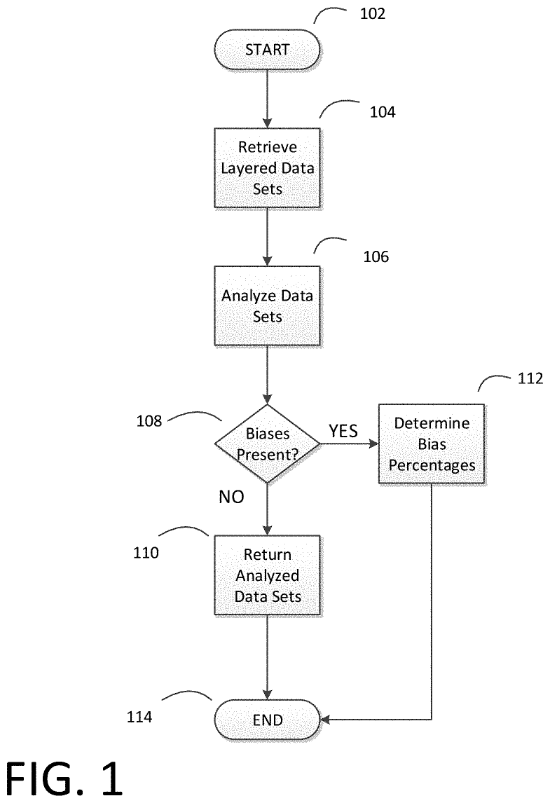

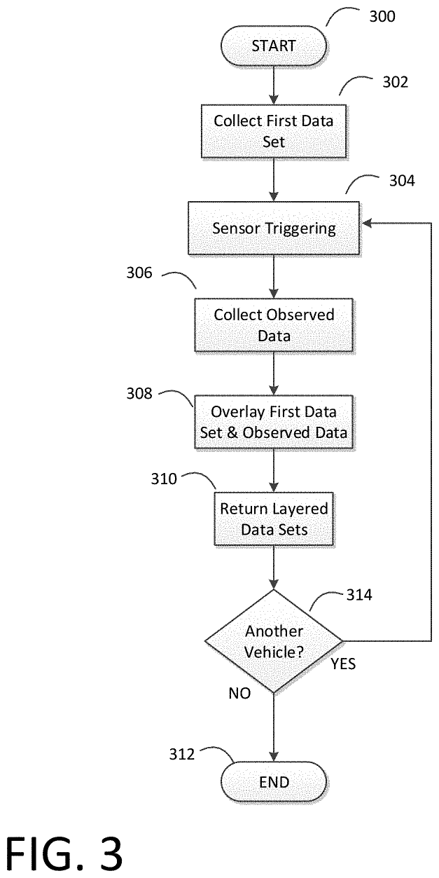

Turning now to FIG. 1, a view of a sub-process for determining data biases in layered datasets consistent with certain embodiments of the present invention is shown. At 102 the sub-process starts. At 104 the system retrieves the layered data sets of FIG. 3. These layered data sets may include data and/or data artifacts from the original collected data sets of FIG. 3. At 106 the system analyzes the Data Sets for the presence of statistical Biases. This analysis results in Analyzed Data Sets. If at 108 no biases are present, then the sub-process returns the Analyzed Data Sets at 110. If at 108 the system determines the presence of biases, then at 112 the system determines bias percentage. At 114 the sub-process ends.

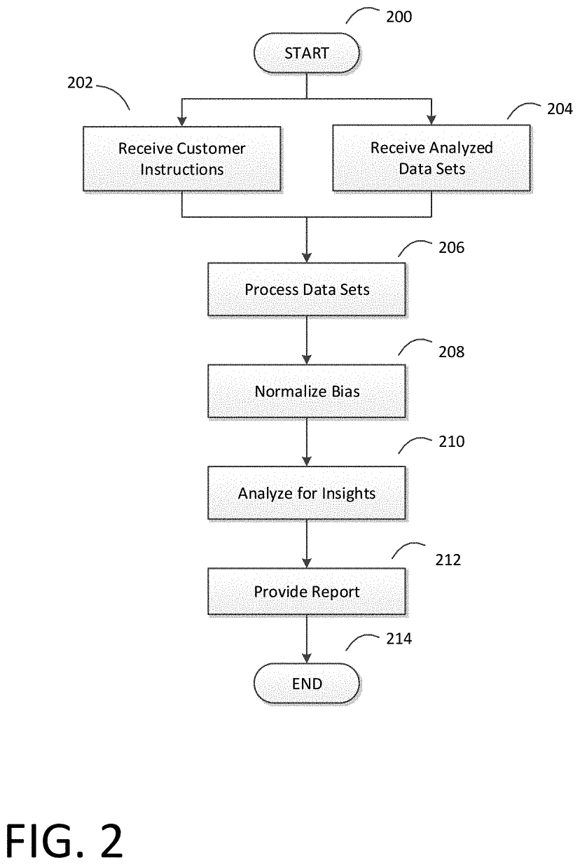

Turning now to FIG. 2, a view of a sub-process for removing data biases and processing a resulting data set consistent with certain embodiments of the present invention is shown. At 200 the sub-process starts. The system receives Customer Instructions at 202 and at 204 the system receives the Analyzed Data Sets of FIG. 1. At 206 the system processes the Analyzed Data Sets in light of the Customer Instructions. By way of non-limiting example, Customer Instruction may direct analysis of traveler behavior upon a specific highway during a specific time of the day. At 208 the system normalizes for the percentage bias determined in FIG. 1. Such normalization may also be accompanied by Data Smoothing. At 210 the system analyzes the normalized output for forward-looking insights into human behavior. At 212 the system provides predictions regarding future human behavior in the form of a report. At 214 the sub-process ends.

Turning now to FIG. 3, a view of a sub-process for returning initial data sets consistent with certain embodiments of the present invention is shown. At 300 the sub-process starts. At 302 the system collects a first data set such as that composed of census or commercial transaction data related to vehicle travelers. At 304 the system may be triggered by ingress and/or egress sensors and/or other traffic data monitors. The sensors and/or monitors recognize that a vehicle has crossed a geographical boundary of interest to a customer. At 306 the system collects observed data about the vehicle that triggered the system. At 308, the system overlays the first data set and the observed data and returns one or more layered data sets at 310. The one or more layered data sets may include data or data artifacts from the collected data sets. If at 314 there is another vehicle, the system returns to the trigger point at 304. If there is not another vehicle, the sub-process ends at 312.

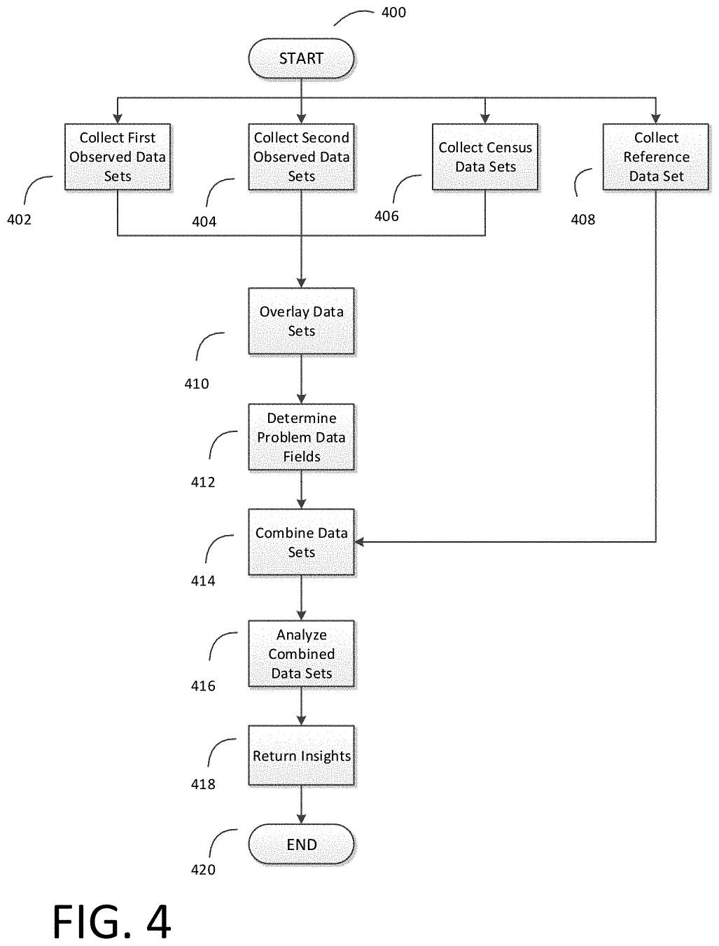

Turning now to FIG. 4, a view of a sub-process for data collection and analysis consistent with certain embodiments of the present invention is shown. The sub-process starts at 400. At 402, the system collects a first observed data set or data sets. The first observed data sets may be collected in response to a triggering event such as the activation of an ingress or egress sensor. The first collected data sets may be observed, by way of non-limiting example, as device GPS data, traffic monitor data, camera data, or satellite data. At 404 the system may collect one or more second observed data set or data sets. The second observed data sets may be collected in response to a triggering event such as the activation of an ingress or egress sensor. The second collected data sets may be observed, by way of non-limiting example, as device GPS data, traffic monitor data, camera data, or satellite data. First and second observed data sets may reflect the position and behavior of the same vehicle operator at two different times. At 406 the system collects one or more census data sets. Census data sets may be collected from, by way of non-limiting example, hotels, motels, amusement parks, or any place providing human lodging and maintaining commercial transaction data. In an embodiment, commercial transaction data that is accessible through a lodger's use of a credit card or lending institution may include such readily-available census information as, by way of non-limiting example, lodger's name, home address, home postal code, phone number, e-mail address, and other personally identifying information. At 408, the system collects a reference data set such as, by way of non-limiting example, archived vehicle registration data. In an embodiment, the reference data is static data within a database of information pertaining to the lodger and/or the vehicle operator. At 410 the dynamically collected data sets of 402, 404, and 406 are overlaid upon each other. This data overlay aligns the various data sets both along a master timeline and by matching records on each file to records on the other files that already include data fields of interest. At 412 the system determines whether any of the data fields sought by the system are missing, inconsistent, or otherwise problematic, and preps those data fields for further analysis. At 414, the reference data sets of 408 are combined with the already overlaid data sets of 410. The combining of 414 is achieved by data overlay of the reference data set upon the overlaid data sets of 410. At 416 the system analyzes the combined data sets according to customer directions. At 418, the system returns insights into human travel behavior in the form of a real-time report. At 420 the sub-process ends.

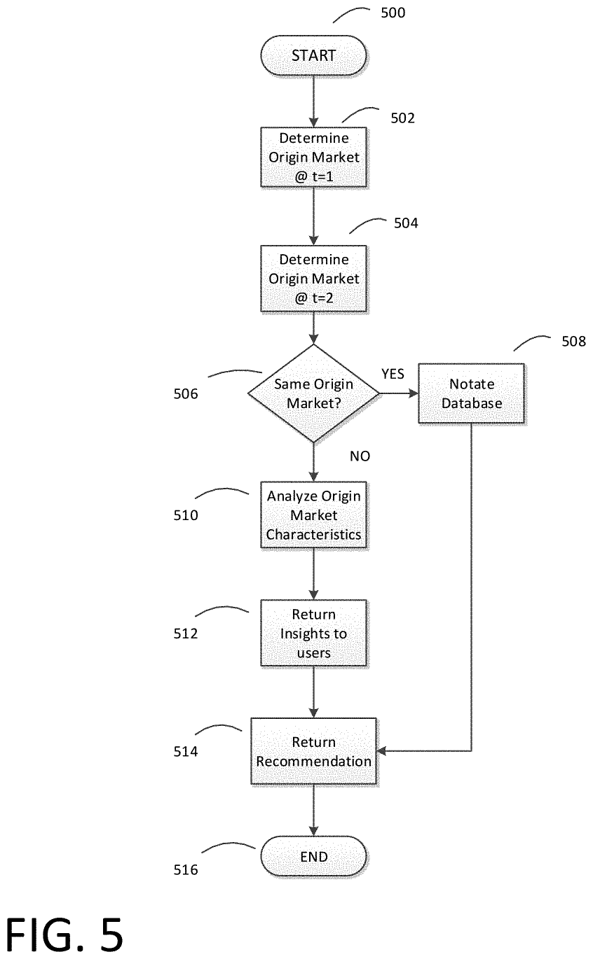

Turning now to FIG. 5, a view of a sub-process for determining changes in origin markets over time consistent with certain embodiments of the present invention is shown. At 500, the sub-process starts. At 502, the system determines the origin market of a vehicle operator at time 1 (t=1). This origin market may represent any geographical location where the vehicle operator is co-located at any given moment t=1 of interest to a customer. The geographical location may be defined broadly as in, by way of non-limiting example, a region or narrowly as in, by way of non-limiting example, a single parking lot. At 504 the system determines the origin market of the vehicle operator at time 2 (t=2). This origin market may represent any geographical location where the vehicle operator is co-located at any given moment t=2 of interest to a customer. The geographical location may be defined broadly as in, by way of non-limiting example, a region or narrowly as in, by way of non-limiting example, a single parking lot. If at 506 the system determines that the origin market at t=1 is identical to the origin market at t=2, then at 508 the system makes a notation in a database and at 514 the system returns a recommendation. If at 506 the system determines that the origin market at t=2 differs from the origin market at t=1, at 510 the system analyzes the characteristics of each origin market in relation to the other. At 512 the system returns insights upon the human behavioral shift, market origin of those staying at a particular property, class of property, and additional insights as evidenced by the change in origin market, class of property, and other parameters. For instance, by way of non-limiting example, if origin market at t=1 is characterized by the presence of healthy sit-down dining but also by a lack of fast-food restaurants, and if origin market at t=2 is characterized by the presence of numerous fast-food restaurants but no healthy dining options, the system may conclude that for one or more reasons the vehicle operator is not principally motivated by health considerations. At 514 the system returns one or more recommendations to the customer based upon the derived insights in light of the customer instructions. The one or more recommendations are returned virtually instantaneously upon the triggering of a sensor by the vehicle operator and the performance of the subsequent data analysis. At 516 the sub-process ends.

While certain illustrative embodiments have been described, it is evident that many alternatives, modifications, permutations and variations will become apparent to those skilled in the art in light of the foregoing description.

What is claimed is:

1. A method for improving estimates of visitor volume to a physical location, comprising:
collecting one or more first data sets, the one or more first data sets representing commercial transaction data of human travelers and including origin information for each of said human travelers;
collecting one or more second data sets in response to a sensor triggering event, one of said one or more second data sets each representing ingress to and/or egress from one or more discretely bounded geographic areas and one of said one or more second data sets representing automobile location data;
associating the one or more first data sets and the one or more second data sets by comparing synchronized timestamps recorded with each of the one or more first data sets and one or more second data sets to create a combined data set;
calculating the presence of one or more statistical biases for said origin information compared with said automobile location data;
normalizing the one or more statistical biases through removing over-indexation of automobile location data within said combined data set and producing a resulting data set;
analyzing the resulting data set for said automobile location data compared with said discretely bounded geographic location to create human behavioral insights into travel behaviors for said human travelers; and
providing a report upon said human behavioral insights to a user to predict future traveler behavior.

2. The method of claim 1, where correcting the one or more statistical biases is affected by applying a multiplier.

3. The method of claim 1, where the human behavioral insights reflect prospective human travel behavior regarding a number of lodgers within a hotel associated with said discretely bounded geographic area.

4. The method of claim 1, where the one or more second data sets capture real-time vehicle data.

5. The method of claim 4, where the real-time vehicle data is captured using a digital device application, and/or a traffic data monitor, and/or a satellite monitor, or where the real-time vehicle data is captured using a combination of any of the digital device application, and/or the traffic data monitor, and/or the satellite monitor.

6. The method of claim 1, where the one or more first data sets include at least hotel data for Average Daily Rate and Occupancy.

7. The method of claim 6, where the hotel data is refreshed and provided on a daily basis.

8. The method of claim 1, where the one or more first data sets include the total occupancy of a hotel, the available occupancy of the hotel upon any given date; the hotel's physical address, and the hotel's taxable rate.

9. The method of claim 1, where the report reveals traveler origin markets and associated marketing data.

10. A system for improving estimates of visitor volume to places, comprising:
a server with a processor in communication with one or more digital devices;
collecting one or more first data sets, the one or more first data sets representing commercial transaction data of human travelers and including origin information for each of said human travelers;
said server collecting one or more second data sets in response to a sensor triggering event, one of said one or more second data sets each representing ingress to and/or egress from one or more discretely bounded geographic areas and one of said one or more second data sets representing automobile location data;
said server associating the one or more first data sets and the one or more second data sets by comparing synchronized timestamps recorded with each of the first data set and one or more second data sets to create a combined data set;
said server calculating the presence of one or more statistical biases for said origin information compared with said automobile location data;
said server normalizing the one or more statistical biases through removing over-indexation of automobile location data and producing a resulting data set;
said server analyzing the resulting data set for automobile location compared with said discretely bounded geographic location to create human behavioral insights into travel behaviors for said human travelers; and
said server providing a report upon said human behavioral insights to a user to predict future traveler behavior.

11. The system of claim 10, where correcting the one or more statistical biases is affected by applying a multiplier.

12. The system of claim 10, where the human behavioral insights reflect prospective human travel behavior regarding a number of lodgers within a hotel associated with said discretely bounded geographic area.

13. The system of claim 10, where the one or more motor vehicle second data sets capture real-time vehicle data.

14. The system of claim 13, where the real-time vehicle data is captured using a digital device application, and/or a traffic data monitor, and/or a satellite monitor, or where the real-time vehicle data is captured using a combination of any of the digital device application, and/or the traffic data monitor, and/or the satellite monitor.

15. The system of claim 10, where the one or more first data sets include at least hotel data for Average Daily Rate and Occupancy.

16. The system of claim 15, where the hotel data is refreshed and provided on a daily basis.

17. The system of claim 10, where the one or more first data sets include the total occupancy of a hotel, the available occupancy of the hotel upon any given date; the hotel's physical address, and the hotel's taxable rate.

18. The system of claim 10, where the report reveals traveler origin markets and associated marketing data.
